(19) United States
(12) Patent Application Publication
(10) Pub. No.: US 2007/0191227 A1
(43) Pub. Date: Aug. 16, 2007

(54) Use of basic amino acids in copper-containing fungicidal formulations

(76) Inventors: Thomas Pfeiffer, Bohl-Iggelheim (DE); Maximilian Angel, Schifferstadt (DE); Adolf Parg, Bad Durkheim (DE)

Correspondence Address: HUTCHISON LAW GROUP PLLC, PO BOX 31686, RALEIGH, NC, 27612, US

(21) Appl. No.: 10/575,209

(22) PCT Filed: Oct. 15, 2004
(86) PCT No.: PCT/EP04/11585

§ 371 Date: Apr. 10, 2006

(30) Foreign Application Priority Data
Oct. 17, 2003 (DE) 103 49 111.2

(51) Int. Cl. A01N 55/02; A01N 25/26

(52) U.S. Cl. 504/100; 514/500

(57) ABSTRACT

Use of basic amino acids in copper-containing fungicidal formulations, preparation of copper-containing formulations comprising basic amino acids, copper-containing formulations comprising basic amino acids and at least one further agrochemical active ingredient, and methods for controlling phytopathogenic fungi using the abovementioned formulations.

The present invention relates to the use of basic amino acids in copper-containing fungicidal formulations, to the preparation of copper-containing formulations comprising basic amino acids, to copper-containing formulations comprising basic amino acids and optionally at least one further agrochemical active ingredient, and to methods for controlling phytopathogenic fungi based on the abovementioned formulations.

Copper salts have already been employed in agriculture for a long time for controlling phytopathogenic fungi on crop plants. To ensure the efficacy of the copper treatment of cultures over a prolonged period, inorganic copper salts Which are sparingly soluble or insoluble in water, such as copper oxychloride, are used most frequently for this purpose.

Frequently, further additives such as complexing agents are added to the copper salt to improve its action and to reduce the application rate.

EP-A 39 788 describes copper amine salts of organic mono-, di- or polycarboxylic acids, where water-soluble, acidic copolymers based on acrylic acid or methacrylic acid and acrylic acid esters or methacrylic acid esters can be used as the polycarboxylic acids. EP-A 237 946 discloses copper amine salts of organic, water-soluble, acidic copolymers based on acrylic acid or methacrylic acid and acrylic acid esters or methacrylic acid esters.

Moreover, the use of copper salts based on low-molecular-weight organic carboxylic acids in oily formulations is known (cf. technical handbook of Complex Quimica S.A. on Complex-200).

WO 02/083599 discloses fungicidally acting fertilizers which comprise a combination of alkali metal hydroxides and alkaline earth metal hydroxides, hydrolyzed proteins and copper salts such as, for example, copper hydroxide.

The amino acid mixture which is liberated from the proteins comprises acidic amino acids, basic amino acids and pH-neutral amino acids in various proportions.

Surprisingly, it has now been found that the use of basic amino acids, preferably lysine, in copper-containing fungicidal formulations improves the fungicidal activity, or brings about the same level of fungicidal activity with a reduced amount of copper or copper salt.

The present invention therefore relates to the use of basic amino acids, preferably lysine, in copper-containing fungicidal agrochemical compositions.

Within this use, it is possible for example to treat at least one copper salt with basic amino acids to obtain in this manner a fungicidal copper-containing formulation according to the invention.

The term copper salt is understood as meaning mono- or, preferably, divalent copper salts of inorganic and organic acids, for example copper oxychloride, copper octanoate, copper ammonium carbonate, copper arsenate, copper oxysulfate, copper formate, copper proprionate, copper oxyacetate, copper citrate, copper chloride, copper diammonium chloride, copper nitrate, copper carbonate, basic copper carbonate, copper pyrophosphate, copper phosphate, disodium copper EDTate, diammonium copper EDTate, copper oxalate, copper tartrate, copper gluconate, copper glycinate, copper glutamate, copper aspartate, copper glutonate, copper adipate, copper palmitate, copper stearate, copper caprylate, copper decanoate, copper undecylenate, copper neodecanoate, copper linoleate, copper oleate, copper borate, copper methanesulfonate, copper sulfamate, copper acetate, copper hydroxide, copper oxide, copper oxychloride sulfate, copper sulfate, basic copper sulfate, oxine-copper, copper bis(3-(phenylsalicylate), copper dihydrazinium disulfate, dicopper chloride trihydroxide and tricopper dichloride dimethyldithiocarbamate. Other copper compounds which are suitable are mixed salts with ammonium, alkali metals and alkaline earth metals. Examples are ammonium copper(II) sulfate, copper(II) magnesium sulfate, copper naphthenate, copper 8-quinolate and copper(II) potassium sulfate. Preference is given to using copper oxychloride, copper octanoate, copper ammonium carbonate, copper arsenate, copper(II) acetate arsenite, copper oxysulfate, copper formate, copper propionate, copper oxyacetate, copper citrate, copper carbonate, copper chloride, copper diammonium chloride, copper nitrate, copper carbonate, basic copper carbonate, copper pyrophosphate, copper phosphate, disodium copper EDTate, diammonium copper EDTate and copper acetate, copper hydroxide, copper oxide, copper oxychloride sulfate, copper sulfate, basic copper sulfate, oxine-copper, copper bis(3-(phenylsalicylate), copper dihydrazinium disulfate, dicopper chloride trihydroxide, copper naphthenate, copper 8-quinolate and tricopper dichloride dimethyidithiocarbamate, especially preferably copper acetate, copper carbonate, copper oxychloride, copper hydroxide, copper oxide, copper oxychloride sulfate, copper sulfate, basic copper sulfate, oxine-copper, copper bis(3-(phenylsalicylate), copper dihydrazinium disulfate, dicopper chloride trihydroxide, copper octanoate, copper ammonium carbonate, copper arsenate, copper oxysulfate, copper naphthenate, copper 8-quinolate and tricopper dichloride dimethyldithiocarbamate.

The term “basic amino acids/basic amino acid” refers to the amino acid in free, betainic form, which may be present in anhydrous form or as a hydrate, such as, for example, lysine monohydrate, or as a salt, such as, for example, arginine monohydrochloride, histidine monohydrochloride, lysine monohydrochloride, arginine dihydrochloride, histidine dihydrochloride or lysine dihydrochloride. The corresponding amino acids are employed in enantiomerically pure form, preferably in the form of their L isomers, or as racemic mixtures. The use of lysine, in particular L-lysine, as basic amino acid is preferred.

The weight ratio of the basic amino acid to copper can be varied within wide ranges, it is generally 100:1 to 1:20 in particular 20:1 to 1:20 parts by weight, preferably 7:1 to 1:10, especially preferably 5:1 to 1:3 parts by weight, especially preferably 3:1 to 1:1 parts by weight.

The compositions preferably comprise 0.01 to 95% by weight of basic amino acid and 0.01 to 80% by weight, in particular 0.01 to 50% by weight, of at least one copper salt, based on copper, and optionally further constituents.

Besides basic amino acids and copper salts, the following components may also be present in the compositions according to the invention, the constituents totaling 100%:
b) a solvent or solvent mixture, preferably 0.1 to 98% by weight, or
c) a basic nitrogen compound, preferably 0.01 to 80% by weight, in particular 1 to 10, in particular 2 to 6 mol equivalents, based on copper, or
d) at least one further fungicidal active ingredient, usually 0.1 to 80% by weight, preferably in a weight ratio of from 50:1 to 1:1000, by preference 1:1 to 1:100, in particular 1:3 to 1:10 (parts by weight of active ingredients: copper), or
e) one or more adjuvants which are suitable for the formulation, preferably 0.1 to 98% by weight, or
f) a combination of at least two of the components mentioned under b) to e).

All of the embodiments of the abovementioned compositions are hereinbelow referred to as “formulations according to the invention”.

One embodiment of the formulations according to the invention comprises:
a′) 0.01 to 80% by weight of one or more basic amino acids, 0.01 to 50% by weight of one or more copper salts, based on copper, and 0.01 to 80% by weight of at least one further fungicidal active ingredient, and
b′) 0.1 to 95% by weight of a solvent or solvent mixture, or
c′) 1 to 10, in particular 2 to 6, mol equivalents, based on copper, of a basic nitrogen compound, or
d′) 0.1 to 95% by weight of adjuvants which are suitable for the formulation, or
f′) a combination of at least two of the components mentioned under b′) to d′).

Copper salts which are preferably used for solid, i.e. for example pulverulent or granulated formulations, are copper salts which are largely insoluble in water, such as copper oxychloride or copper hydroxide. Copper salts which are preferably used for liquid or dispersed formulations are soluble copper salts such as, for example, copper sulfate.

Examples of inventive formulation types are emulsifiable concentrates (EC, EW), suspensions (SC), soluble concentrates (SL), dispersible concentrates (DC), pastes, lozenges, wettable powders, dusts (DP) or granules (GR, FG, GG, MG) which can be either water-soluble or dispersible (wettable). The preparation of these formulations and the technology required for this is known to the skilled worker (see, for example, U.S. Pat. No. 3,060,084, EP-A 707445 (for liquid concentrates), Browning, “Agglomeration”, Chemical Engineering, Dec. 4, 1967, 147-48, Perry's Chemical Engineer's Handbook, 4th Ed., McGraw-Hill, N.Y., 1963, pp. 8-57 et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Federal Republic of Germany), 2001).

Component (b) is to be understood as comprising solvents such as, for example, water, aromatic solvents (for example Solvesso Products, xylene), paraffins (for example mineral oil fractions), alcohols (for example methanol, butanol, pentanol, benzyl alcohol), ketones (for example cyclohexanone, gamma-butryolactone), pyrrolidones (NMP, NOP), acetates (glycol diacetate), glycols, dimethyl fatty acid amides, fatty acids and fatty acid esters. In principle, solvent mixtures may also be used. Solvents which are preferably employed are water, N-methylpyrrolidone (NMP), cyclohexanone and gamma-butyrolactone. Usually, 0.1 to 98% by weight of solvents are present in liquid formulations.

The term “basic nitrogen compounds” c) is understood as meaning for example ammonia (formation of copper amine complexes), primary and secondary amines such as, for example, ethylene diamine and propylene diamine, preferably ammonia.

The formulations according to the invention optionally comprise 0.1 to 80% by weight of basic nitrogen compounds, preferably 1 to 10, in particular 2 to 6 moI equivalents, based on copper. Alternatively, 1 equivalent, less than 1 equivalent or even smaller amounts of nitrogen compounds may be present. Higher amounts, such as up to 50 equivalents, are also possible.

The term “adjuvants which are suitable for the formulation” e) are generally understood as meaning the following classes of substances:

Surfactants such as wetters, stickers or dispersants, antifoams, thickeners, carriers, antifreeze agents and bactericides.

Usually, 0.1 to 99% by weight of carriers are present in solid formulations. Other adjuvants usually amount to 0.1 to 30% by weight.

The importance and the corresponding use of the abovementioned substances depends on the intended type of formulation and on the nature of the active ingredient.

Examples of thickeners (i.e. compounds which impart pseudoplastic flow behavior to the formulation, i.e. high viscosity in the quiescent state and low viscosity in the agitated state) are, for example polysaccharides or organic sheet minerals, such as xanthan gum (Kelzan® from Kelco), Rhodopol® 23 (Rhone Poulenc) or Veegum® (R. T. Vanderbilt) or Attaclay® (Engelhardt).

Examples of suitable antifoams are silicon emulsions (such as, for example, Silikon® SRE, Wacker or Rhodorsil® from Rhodia), long-chain alcohols, fatty acids, organofluorine compounds and their mixtures may be considered.

Bactericides may be added to stabilize the aqueous fungicide formulation. Examples of suitable bactericides are Proxel® from ICI or Acticide® RS from Thor Chemie and Kathon® MK from Rohm & Haas.

Examples of suitable antifreeze agents are ethylene glycol, propylene glycol or glycerol.

Examples of carriers are ground natural minerals, (for example kaolins, clays, talc, chalk) and ground synthetic materials (for example highly-dispersed silica, silicates), and examples of emulisifers are nonionic and anionic emulsifiers (for example polyoxyethylene fatty alcohol ethers, alkylsulfonates and arylsulfonates) and dispersants as mentioned hereinbelow.

Examples of surfactants are alkali metal salts, alkaline earth metal salts and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalene sulfonic acid with phenol and formaldehyde, polyoxyethylene octylphenol ether, ethoxylated isooctylphenol, octylphenol, nonylphenol, alkylphenyl polyglycol ethers, tributylphenyl polyglycol ether, tristerylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for preparing directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene,. paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone or water.

Powders, materials for spreading and dusts can be prepared by mixing or concomitantly grinding the active substances together with a solid carrier.

Granules, for example coated granules, impregnated granules and homogeneous granules can be prepared by binding the active ingredients to solid carriers. Examples of solid carriers are mineral earths such as silica gels, silicates, talc, kaolin, Attaclay, limestone, lime, chalk, bole, loess, clay, dolomite, diatomaceous earth, calcium sulfate, magnesium sulfate, magnesium oxide, ground synthetic materials, fertilizers such as, for example, ammonium sulfate, ammonium phosphate, ammonium nitrate, ureas and products of vegetable origin, such as cereal meal, tree bark meal, wood meal and nutshell meal, cellulose powder and other solid carriers.

All of the embodiments of the abovementioned fungicidally active agrochemical compositions are hereinbelow referred to as “compositions according to the invention”.

The term “at least one further fungicidal active ingredient” d) means that, besides copper, either one or more further fungicidal active ingredients may be added to the compositions according to the invention as further components; in this context, the following are particularly suitable:
Acylalanines such as benalaxyl, metalaxyl, ofurace, oxadixyl,
Amine derivatives such as aldimorph, dodine, dodemorph, fenpropimorph, fenpropidin, guazatine, iminoctadine, spiroxamin, tridemorph,
Anilinopyrimidines such as pyrimethanil, mepanipyrim or cyrodinyl,
Antibiotics such as cycloheximide, griseofulvin, kasugamycin, natamycin, polyoxin, oxytetracyclin or streptomycin,
Azoles such as bitertanol, bromoconazole, cyproconazole, difenoconazole, dinitroconazole, enilconazole, epoxiconazole, fenbuconazole, fluquiconazole, flusilazole, hexaconazole, imazalil, metconazole, myclobutanil, penconazole, propiconazole, prochloraz, prothioconazole, tebuconazole, triadimefon, triadimenol, triflumizol, triticonazole,
Dicarboximides such as iprodione, myclozoline, procymidone, vinclozoline,
Dithiocarbamates such as ferbam, nabam, maneb, mancozeb, metam, metiram, propineb, polycarbamate, thiram, ziram, zineb,
Heterocylic compounds such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolan, mepronil, nuarimol, probenazole, proquinazid, pyrifenox, pyroquilon, quinoxyfen, silthiofam, thiabendazole, thifluzamide, thiophanate-methyl, tiadinil, tricyclazole, triforine,
Nitrophenyl derivatives such as binapacryl, dinocap, dinobuton, nitrophthal-isopropyl,
Phenylpyrroles such as fenpiclonil or fludioxonil,
Sulfur,
Other fungicides such as acibenzolar-S-methyl, benthiavalicarb, carpropamid, chlorothalonil, cyflufenamid, cymoxanil, dazomet, diclomezine, diclocymet, diethofencarb, edifenphos, ethaboxam, fenhexamid, fentin acetate, fenoxanil, ferimzone, fluazinam, fosetyl, fosetyl aluminum, iprovalicarb, hexachlorobenzene, metrafenon, pencycuron, propamocarb, phthalide, toloclofos-methyl, quintozene, zoxamid, benzalkonium chloride or hydroxyquinoline sulfate,
Strobilurins such as azoxystrobin, dimoxystrobin, fluoxastrobin, kresoxim-methyl, metominostrobin, orysastrobin, picoxystrobin, pyraclostrobin or trifloxystrobin,
Sulfenic acid derivatives such as captafol, captan, dichlofluanid, folpet, tolylfluanid,
Cinnamamides and analogues such as dimethomorph, flumetover or flumorph.

Further examples of fungicides can be found in Pesticide Manual, 12th Edition, London ©2000.

Preferably, at least one of the fungicidal active ingredients from the abovementioned groups which are possible is employed as active ingredient. Especially preferably, the active ingredient is selected from the group consisting of the following active ingredients:
Acylalanines such as benalaxyl, metalaxyl, ofurace or oxadixyl,
Antibiotics such as cycloheximide, griseofulvin, kasugamycin, natamycin, polyoxin, oxytetracyclin or streptomycin,
Amine derivatives such as guazatine or iminoctadine,
Azoles such as bitertanol, bromoconazole, cyproconazole, difenoconazole, dinitroconazole, epoxiconazole, fenbuconazole, fluquiconazole, flusilazol, hexaconazole, imazalil, metconazole, myclobutanil, penconazole, propiconazole, prochloraz, prothioconazole, tebuconazole, triadimefone, triadimenol, triflumizol, triticonazole,
Dithiocarbamates such as ferbam, nabam, maneb, mancozeb, metam, metiram, propineb, polycarbamate, thiram, ziram, zineb,
Heterocylic compounds such as anilazine, boscalid, carbendazim, cyazofamid, dazomet, dithianon, famoxadone, fenamidone, flutolanil, furametpyr, mepronil, nuarimol, pyrifenox, silthiofam, thiabendazole, thifluzamide, thiophanate-methyl, tiadinil,
Sulfur,
Other fungicides such as acibenzolar-S-methyl, benthiavalicarb, chlorothalonil, cymoxanil, dazomet, diclomezine, diclocymet, diethofencarb, edifenphos, ethaboxam, fenhexamid, fentin acetate, fenoxanil, fluazinam, fosetyl, fosetyl-aluminum, iprovalicarb, hexachlorobenzene, pencycuron, propamocarb, quintozene, zoxamid, benzalkonium chloride or hydroxyquinoline sulfates,
Strobilurins such as azoxystrobin, dimoxystrobin, fluoxastrobin, kresoxim-methyl, metominostrobin, orysastrobin, picoxystrobin, pyraclostrobin or trifloxystrobin, and
Sulfenic acid derivatives such as captafol, captan, dichlofluanid, folpet, tolylfluanid
Cinnamamides and analogues such as dimethomorph, flumetover or flumorph.

Examples of synergistic mixtures comprising copper and at least one further fungicidal active ingredient from the class of the strobilurins are disclosed for example in WO 97/15189 and WO 00/30450, these active ingredient combinations are particularly preferred in the compositions according to the invention.

Examples of preferred mixtures of copper and at least one further fungicidal active ingredient are mixtures comprising

copper salt(s) and cymoxanil,

copper salt(s) and dichlorfluanid,

copper salt(s),cymoxanil and dichlorfluanid,

copper salt(s) and mancozeb,

copper salt(s), cymoxanil and mancozeb,

copper salt(s), cymoxanil and metiram,

copper salt(s) and dimethomorph,

copper salt(s) and hydroxyquinoline sulfate,

copper salt(s) and kasugamycin,

copper salt(s), macozeb and sulfur,

copper salt(s) and maneb,

copper salt(s) and propineb,

copper salt(s), triadimefon and propineb,

copper salt(s) and zineb,

copper salt(s) and folpet,

copper salt(s) and carbendazim,

copper salt(s) and metalaxyl,

copper salt(s) and metiram,

copper salt(s) and benalaxyl,

copper salt(s) and chlorothalonil,

copper salt(s) and oxadixyl,

copper salt(s) and zineb,

copper salt(s) and sulfur,

copper salt(s) and benzalkonium chloride,

copper salt(s) and streptomycin and oxytetracyclin,

copper salt(s) and pyraclostrobin and

copper salt(s) and kresoxim-methyl.

The ratio of the further fungicidal active ingredient to copper in formulations according to the invention which comprise at least one further fungicidal active ingredient preferably amounts to from 50:1 to 1:1000, preferably from 1:1 to 1:100, in particular from 1:3 to 1:10 (parts by weight active ingredient/copper).

A formulation according to the invention which comprises only copper as fungicidal active ingredient can be prepared for example by treating basic amino acids with at least one copper salt. This can be carried out in solid phase, for example by mixing the components, or in liquid phase, for example by mixing the components in a solvent, by procedures known to the skilled worker. Suitable solvents are those mentioned under (b). When preparing the formulations according to the invention, lysine is preferably employed as the hydrochloride, for reasons of practicality.

In the case of preparation in liquid phase, the solvent can be removed once the preparation has ended or else remain in the formulation according to the invention as further component (b). It is also possible to treat a solid composition according to the invention with a solvent (b) in a manner known per se.

The preparation of a formulation according to the invention comprising, as further component, a basic nitrogen compound (c) and, if appropriate, a solvent (b) is preferably based on reacting, or mixing, the copper salt with a basic nitrogen compound (c). The resulting reaction product is reacted or mixed with the basic amino acids. A further preferred variant consists in first reacting or mixing the copper salt with the basic amino acids. The reaction can be carried out in a solvent by procedures known to the skilled worker. Suitable solvents are the solvents (b).

Moreover, adjuvants (e) may also be added during the preparation.

If required, the end product obtained can be dried prior-to further processing.

Formulations according to. the invention which additionally comprise at least one further fungicidal active ingredient (d) can be prepared by treating copper and basic amino acids together with at least one further fungicidal active ingredient and with adjuvants which are suitable for formulation, and formulating the mixture in a known manner.

As an alternative, the formulation according to the invention may also be prepared by treating the composition according to the invention together with at least one further fungicidal active ingredient and with adjuvants which are suitable for formulation and formulating the mixture in a known manner.

The formulation with the further fungicidal active ingredient and with the adjuvants which are suitable for the formulation can be prepared in the solid or liquid phase.

Moreover, a formulation which comprises only copper as fungicidal active ingredient can be treated with basic amino acids and.at least one further fungicidal active ingredient and also with suitable adjuvants for the formulation, and formulated in the known manner.

In this context, the formulation which only comprises copper as fungicidal active ingredient may also be commercially available.

Examples of commercially available formulations which comprise copper as fungicidal active ingredient are

Copper-Count-N*, Cupromin *(copper ammonium carbonate)

Carbocob*, Carbocop*, Carboflow* (copper carbonate)

Aciocide*, Cudrox*, Cuidrox*, Blue Shield*, Kocide*, Spin Out*, Hidrocop, Hidroflow*,

Hydrocop*, Champ* DP, Champ*, Formula2*, Champinion*, Comac Parasol*,

Cuproxide*, Parkens*, Funguran-OH*, Hermoo Koperhydroxide*, Koicide*, KOP*

hydroxide, Qeusturan*, Nu-Cop*,

Bordelesa*, FT-2*, Poltiglia Caffaro*, Bordocop*, Bordoflow*, Comac* (Bordeaux mixture)

Flo-Bordo* (Bordeaux mixture and copper hydroxide)

Chapco Cu-Nap*, Troysan*, Wittox C*, Wiltz-65* (copper naphthenate)

Chem Copp*, Chemet AGcopp 75*, Cuprocop*, Cuprox*, Nordox Super 75, Oleo

Nordox*, Nordox* S-45, Nordox* 50, Nordox* AgroTech, Parkenox-50, Parkens,

Caocobre*, Copper Sandoz*, Cupra*, Nordox*, Ploxiram (copper oxide)

Coptox*, Aviocaffaro*, Cuporcaffaro*, Neoram*, Pasta Caffaro*, Polvere Caffaro*,

Rame Caffaro*, Criscobre*, COC*, KOP* OXY-85, CO-TOX*, Oxicop*, Oxycop*

Oxiflow, Cuprarikh-35*, Cuprarikh-50*, Parkens*, Cuprozin*, Nicuran*, Combat*,

BluDiamdond*, TopGun*, Recop*, Kupoxil*, Acicio*, Agro-Bakir*, Agroram*, Blitox*,

BlueCap*, Bluevit*, Cobox*, Cobre Lainco*, Coprantol*, Cupramar*, Cupravit*, Copter*,

Coupradin*, Criscobre*, Crystal*, Cuprenox*, Cuprex*, Cuprossina*, Cuproflow*,

Cuproxima*, Devicopper*, Dhanucop*, Dongoxyclorua*, Hektas Bakir*, Hilcopper*,

Kapper*, Koruma Bakir*, Micorsperse*, Midiltipi Virfix Bakir*, Perecopper*, Pol-Kupritox* (copper oxychloride)

Oxycop Dry S*, Copro*, Coxysul*, CS-56*, COCS*, CSC*, Oxycop* (copper oxychloride sulfate)

Mitrol PQ*, Oxichem*, PQ-8* (copper 8-quinolate)

Bouille Bordelaise RSR*, Hektas Goztasi*, Sulfacop*, Sulfacob*, Parkens*, Triangle

Brand*, KT-1 9827*, Phyton-27*, (copper sulfate)

Ramenox P.B. (copper sulfate and Bordeaux mixture)

Cuprofix*, Disperss*, Cuprofix* MZ Dispers* Basic Copper 53*, Cop-O-Zinc 25-25*,

Basicop*, Basiflow*, Tricop*, Copper Powder*, Flurame*, KOP 300*, (copper sulfate (basic))

Sultricob*, Sultricop*, Sultriflow*, Tribaflow*, Cuproxat*, Flurane*, Idorame*, King (copper sulfate (tribasic))

*Trade name/®/™

Moreover, an agrochemical formulation comprising copper as the only fungicidal active ingredient can be treated with basic amino acids and with an agrochemical formulation of a further fungicidal active ingredient which comprises no copper or basic amino acids.

An agrochemical formulation refers to all formulations of fungicidal active ingredients, preferably to formulations of the fungicidal active ingredients which have been mentioned as preferred.

In this context, this agrochemical formulation of a further fungicidal active ingredient which comprises no copper or basic amino acid may also be a commercially available formulation.

Moreover, an agrochemical formulation which may also be commercially available and which comprises copper and at least one further fungicidal active ingredient may be treated with basic amino acids.

Examples of commercially available formulations comprising copper and at least one further fungicidal active ingredient are

Idroxanil*, Copral*, Kuoxoate*, Glober*, Expert Team* (copper salt(s) and cymoxanil)

Bakreni Euparen* (copper salt(s) and dichlorfluanid)

Euparen* Ramato Mirco CM (copper salt(s), cymoxanil and dichlorfluanid)

Tripuprozeb Forte S*, Cuprofix*, Junction*, ManKocide*, Mantox-Forte*, Cuprofix* 30 (copper salt(s) and mancozeb),

Zymoman*, Mantox*, Oxicob-mix* copper salt(s) (cymoxanil and mancozeb),

Aviso Cup (copper salt(s), cymoxanil and metiram),

Forum* RC (copper salt(s) and dimethomorph),

copper salt(s) and hydroxyquinoline sulfate (Sellapro*),

Kasumin*-Bordeaux, New Kasuran* (copper salt(s) and kasugamycin),

Mantox-Forte*, Kuprosolor* (copper salt(s), macozeb and sulfur)

Cuprofix M, Herkul*, Cuprofix* M (copper salt(s) and maneb),

Cupro-Antracol**, Antracol* copper, Antracol* Ramato Micro, Cupro-Antracol*,

Cuprotaifen* (copper salt(s) and propineb),

Antracol* Triple (copper salt(s), triadimefone and propineb),

Cupro-Phynebe (copper salt(s) and zineb),

Cupror F, Comac 23-35, Macc F23-35, SuperMacclesfield F23-35, Folcoflow,

Folcop*, Nobac*, Tepeta*, Tepeta Combi* (copper salt(s) and folpet)

Saynko* (copper salt(s) and carbendazim)

CuMeta*, Ridomil Gold copper, Aromil Plus*, Cure-Plus*, Vacomil plus*, Viroxyl* (copper salt(s) and metalaxyl)

Kauritril* (copper salt(s) and metiram)

Galben* C, Galben*, Tairel* C, Vilben-C* (copper salt(s) and benalaxyl)

Clorocaf Ramato*, Gunner*, Citrano*, Optimist* (copper salt(s) and chlorothalonil)

Sandofan* C (copper salt(s) and oxadixyl)

Cuprosan*, Vizincop*, Zina* (copper salt(s) and zineb)

COCS* 15 Sulfur 25 Dust, Copper/Sulfur Flowable*, TopCop* with sulfur (copper salt(s) and sulfur)

Mossoff* (copper salt(s) and benzalkonium chloride)

Cuprimicin*-500 (copper salt(s) and streptomycin and oxytetracyclin)

*Trade name/®/™

In all of the abovementioned methods, the resulting formulations according to the invention may be liquid or solid (for example EC, EW, SC, SL, DC, or wettable powders or water-dispersible granules which can be either soluble or dispersible (wettable) in water).

Examples of formulations are: 1. Products for dilution in water

A. Water-Soluble Concentrates (SL)

10 parts by weight of a copper salt/amino acid mixture according to the invention are dissolved in water or a water-soluble solvent. As an alternative, wetters or other adjuvants are added. Dilution in water gives a solution.

B. Dispersible Concentrates (DC)

20 parts by weight of a copper salt/amino acid mixture according to the invention are dissolved in cyclohexanone with addition of a dispersant, for example polyvinylpyrrolidone. Dilution in water gives a dispersion.

C. Emulsifiable Concentrates (EC)

15 parts by weight of a copper salt/amino acid mixture according to the invention are dissolved in xylene with addition of calcium dodecylbenzenesulfonate and castor oil ethoxylate (in each case 5%). Dilution in water gives an emulsion.

D. Emulsions (EW, EO)

40 parts by weight of a copper salt/amino acid mixture according to the invention are dissolved in xylene with addition of calcium dodecylbenzenesulfonate and castor oil ethoxylate (in each case 5%). This mixture is introduced into water using an emulsifier (Ultraturrax) and made into a homogeneous emulsion. Dilution in water gives an emulsion.

E. Suspensions (SC, OD)

In an agitated ball mill, 20 parts by weight of a copper salt/amino acid mixture according to the invention are comminuted with addition of dispersants and wetters and water or an organic solvent to give a fine active ingredient suspension. Dilution in water gives a stable suspension.

F. Water-Dispersible and Water-Soluble Granules (WG, SG)

50 parts by weight of a copper salt/amino acid mixture according to the invention are ground finely with addition of dispersants and wetters and made into water-dispersible or water-soluble granules by means of technical appliances (for example extrusion, spray tower, fluidized bed). Dilution in water gives a stable dispersion or solution.

G. Water-Dispersible and Water-Soluble Powder (WP, SP)

75 parts by weight of a copper salt/amino acid mixture according to the invention are ground in a rotor-stator mill with addition of dispersants, wetters and silica gel. Dilution in water gives a stable dispersion or solution.

2. Products to be Applied Undiluted

H Dusts (DP)

5 parts by weight of a copper salt/amino acid mixture according to the invention are ground finely and mixed intimately with 95% of finely divided kaolin. This gives a dust.

I. Granules (GR, FG, GG, MG)

0.5 part by weight of a copper salt/amino acid mixture according to the invention is ground finely and associated with 95.5% of carriers. Current methods are extrusion, spray-drying or the fluidized bed. This gives granules to be applied undiluted.

J ULV Solutions (UL)

10 parts by weight of a copper salt/amino acid mixture according to the invention are dissolved in an organic solvent, for example xylene. This gives a product to be applied undiluted.

The active ingredients can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of copper/amino acid.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active ingredient concentrations in the ready-to-use preparations can be varied within relatively wide ranges. In general, they are from 0.0001 to 10%, preferably from 0.01 to 1%.

The active ingredients may also be used successfully in the ultra-low-volume method (ULV), it being possible to apply formulations comprising over 95% by weight of active ingredient, or even to apply the active ingredient without additives.

Oils of various types, wetters, adjuvants, herbicides, fungicides, other pesticides, or bactericides may be added to the active ingredients, even, if appropriate, just immediately prior to use (tank mix). These agents are admixed with the compositions according to the invention, usually done in a weight ratio from 1:10 to 10:1.

The compositions and formulations according to the invention are suitable for controlling phytopathogenic fungi: The present invention therefore relates to a method for controlling phytopathogenic fungi, which comprises applying a composition according to the invention to the harmful organism in question or to the materials, plants, soil and seeds to be protected from the harmful organism in question.

Moreover, the copper/lysine mixtures according to the invention are suitable for controlling harmful fungi such as Paecilomyces variotii in the protection of materials (for example timber, paper, paint dispersions, fibers or wovens) and in the protection of stored products.

Depending on the nature of the copper salt and the desired effect, the application rates of the active ingredients copper and lysine are 0.01 to 10 kg/ha, by preference 0.05 to 5 kg/ha, in particular 0.05 to 2 kg/ha.

For the treatment of seed, mixture application rates of from 0.1 to 2.5 kg/100 kg of seed, by preference 0.1 to 1.0 kg/100 kg, in particular 1 to 0.5 kg/100 kg, are generally used.

When applied in the protection of materials or stored products, the application rate of copper/lysine mixture depends on the nature of the field of application and the desired effect. Customary application rates in the protection of materials are, for example, from 0.0001 g to 2 kg, preferably 0.005 g to 1 kg, of copper/lysine mixture according to the invention per cubic meter of treated material. The use in the protection of timber is preferred.

The method for controlling harmful fungi is carried out by applying the formulations according to the invention by spraying or dusting the seeds, the plants or the soils before or after the plants have been sown, or before or after the plants have emerged.

In this context, it is possible either directly to use a formulation according to the invention or a composition according to the invention prior to application to the harmful organism in question or to the materials, plants, the soil and seeds to be protected from the harmful organism in question with a commercially available agrochemical formulation. As an alternative, it is possible to treat a copper-comprising formulation which, besides copper as fungicidal active ingredient, may, if appropriate, comprise at least one further fungicidal active ingredient, with basic amino acids prior to application to the harmful organism. Examples of copper-comprising formulations which, besides copper as fungicidal active ingredient, may, if appropriate, comprise a further fungicidal active ingredient are abovementioned commercially available copper-comprising formulations.

Application of the fungicidal compositions may be effected curatively, eradicatively or protectively.

The formulations (or compositions) according to the invention are particularly important for controlling a multiplicity of phytopathogenic fungi on a variety of crop plants such as wheat, rye, barley, oats, rice, maize, turf, bananas, cotton, soy, coffee, sugarcane, vines, fruit species, ornamentals and vegetable species such as cucumbers, beans, tomatoes, potatoes and cucurbits, and on the seeds of these plants.

The formulations according to the invention are particularly advantageously suitable for the control of the following plant diseases:
Alternaria species on vegetable and fruit,
Bipolaris and Drechslera species on cereals, rice and turf,
Botrytis cinerea (gray mold) on strawberries, vegetables, ornamentals and vines,
Fusarium and Verticillium species on a variety of plants,
Hemileia vastatrix on coffee
Mycosphaerella species on cereals, bananas and peanuts,
Phytophthora infestans on potatoes and tomatoes,
Plasmopara viticola on vines,
Pseudoperonospora species on hops and cucumbers,
Septoria tritici and Stagonospora nodorum on wheat,
Ustilago species on cereals and sugarcane, and
Venturia species (scab) on apples and pears.

The invention is illustrated by the examples which now follow. Further formulations according to the invention are obtained by suitably modifying the starting materials or the quantitative ratios.

### EXAMPLES

### Example 1

### Preparation of the Formulation “Lysine”

In a 500 ml glass flask, 98.25 g of an aqueous 20% by weight strength copper sulfate solution (copper salt: copper sulfate pentahydrate) were treated with 139.2 g of water, with stirring. Thereafter, 12.5 g of monolysine (solid) were stirred in over 15 minutes, and stirring was continued for 1 hour. This gave a dark blue solution with a copper (ion) content of 2% by weight. The weight ratio of lysine to copper was 2.5.

### Example 2

### Preparation of the Formulation “Lysine with Ammonia”

In a 500 ml glass flask, 98.25 g of an aqueous 20% by weight strength copper sulfate solution (copper salt: copper sulfate pentahydrate) were treated with 107 g of water, with stirring. Thereafter, 12.5 g of monolysine (solid) were stirred in over 15 minutes, 32.2 g of 25% strength ammonia were then added and stirring was continued for 1 hour. This gave a dark blue solution with a copper (ion) content of 2% by weight. The weight ratio of lysine to copper was 2.5.

### Example 3

### Preparation of a Formulation “Lysine with Ammonia”

47.62 kg of fully demineralized water were introduced into a 100 I vessel (equipped with crossbar stirrer). 3.8 kg of lysine monohydrochloride (79% lysine) were added with stirring (50 U/min). After the mixture had been mixed for 30 minutes, 4.72 kg of copper(II) sulfate pentahydrate were added slowly, and the mixture was mixed for 2 hours. Then, 3798 g of aqueous 25% strength ammonia solution were added. After the mixture had been mixed for a further 2 hours, a dark blue solution with a copper content of 1.9% by weight was obtained. The weight ratio of lysine to copper is 2.5. The resulting solution has a solids content of 13% by weight and a pH of 8.2.

### Example 4

### Preparation of a Solid Formulation

66.3 g of lysine hydrochloride (79% lysine) and 33.7 g of copper(II) hydroxide (purity 62.1%) were homogenized and comminuted in a mill (from IKA, type: Analytical Mill A 10). The blue powder obtained had a copper content of 20.9% by weight and a weight ratio of lysine to copper of 2.5.

By admixing water, an aqueous solution comprising 0.1% by weight of copper and having a pH of 7.4 was obtained.

### Example 5

### Preparation of a Formulation “Lysine”

98.25 g of an aqueous 20% by weight strength copper sulfate solution were introduced into a stirred 500 ml glass flask. After addition of 145.4 g of water, 6.25 g of monolysine (L-lysine in solid form) were stirred in over 15 minutes, and stirring was continued for 1 hour. This gave a dark blue solution with a copper (ion) content of 2% by weight. The weight ratio of lysine to copper was 1.25.

### Use Example 1

### Efficacy of the Formulations According to the Invention Against Downy Mildew of Grapevines, Caused by Plasmopara viticola

Leaves of grapevines cv. “Müller-Thurgau” in pots were sprayed to runoff point with aqueous suspension with the active ingredient concentration stated hereinbelow. The suspension or emulsion was made with a stock solution with 1% formulation in water. To allow the longer-term action of the substances to be assessed, the plants were placed in the greenhouse for 7 days after the spray coating had dried on. Only then were the leaves inoculated with an aqueous suspension of Plasmopara viticola. Thereafter, the vines were placed first for 48 hours into a chamber at 24° C. and 100% atmospheric humidity and then for 5 days in the greenhouse at temperatures of between 20° C. and 30° C. After this time, the plants were returned into a humid chamber for 16 hours to accelerate the eruption of sporangiophores. The extent of disease on the undersides of the leaves was then determined visually.

TABLE 1

| | Cu | | |
|---|---|---|---|
| Example | concentration | Formulation | Efficacy |
| 1 | 0.02% | Lysine (2% copper) of Ex. 1 | 95% |
| 2 | 0.02% | Lysine/NH₃ (2% copper) of Ex. 2 | 84% |
| 3 | 0.45% | Funguran ® (commercial copper | 82% |
| | | fungicide, 45% copper) | |
| 4 | — | Control | 0 |

The results shown in table 1 demonstrate that the formulations according to the invention which only comprise 2% of copper were more effective at equal application rates than the commercially available formulation Funguran® employed, which comprises 45% copper.

### Use Example 2

### Efficacy of Formulations According to the Invention Comprising Copper and a Further Fungicidal Active Ingredient Against Septoria tritici.

A growth assay was carried out with Septoria tritici as indicator fungus. The fungal growth was measured photometrically by the increase in absorption or light scattering as a function of mycelium density. The data were converted into percent growth inhibition, the absorption of the untreated controls being defined as 0% inhibition and that of a killed spore suspension as reference as 100% inhibition.

The expected efficacies of combinations of active ingredients were determined using Colby's formula (Colby, S. R. “Calculating synergistic and antagonistic responses of herbicide combinations”, Weeds, 15, pp. 20-22, 1967) and compared with the observed efficacies.

Colby's formula:
E=x+y−x·y/100
E expected efficacy, expressed in % of the untreated control, when using the mixture of the active ingredients A and B at the concentrations a and b
x efficacy, expressed in % of the untreated control, when using the active ingredient A at the concentration a

y efficacy, expressed in % of the untreated control, when using the active ingredient B at the concentration b

TABLE 2
Individual active ingredients

| | | | Active ingredient | Growth |
|---|---|---|---|---|
| | Active | | concentration | inhibition |
| Ex. | ingredient | Formulation | [ppm] | [%] |
| 5 | Control | | — | 0 |
| | (untreated) | | | |
| 6 | Ia | lysine/NH₃ | 1 | 0 |
| | copper | (from Ex. 3) | 3 | 0 |
| | | | 10 | 0 |
| | | | 33 | 0 |
| 7 | Ib | lysine | 1 | 0 |
| | copper | (from Ex. 4) | 3 | 0 |
| | | | 10 | 0 |
| | | | 33 | 0 |
| 8 | II | — | 1 | 73 |
| | Pyraclostrobin | | | |

TABLE 3
mixtures according to the invention

| | Active ingredient mixture | | |
|---|---|---|---|
| | concentration | | Calculated |
| Example | Mixing ratio | Observed efficacy | efficacy*) |
| 9 | Ia + II | 89 | 73 |
| | 1 + 1 ppm | | |
| | 1:1 | | |
| 10 | Ia + II | 83 | 73 |
| | 3 + 1 ppm | | |
| | 3:1 | | |
| 11 | Ia + II | 92 | 73 |
| | 10 + 1 ppm | | |
| | 10:1 | | |
| 12 | Ia + II | 94 | 73 |
| | 33 + 1 ppm | | |
| | 33:1 | | |
| 13 | Ib + II | 97 | 73 |
| | 1 + 1 ppm | | |
| | 1:1 | | |
| 14 | Ib + II | 93 | 73 |
| | 3 + 1 ppm | | |
| | 3:1 | | |
| 15 | Ib + II | 90 | 73 |
| | 10 + 1 ppm | | |
| | 10:1 | | |
| 16 | Ib + II | 91 | 73 |
| | 33 + 1 ppm | | |
| | 33:1 | | |

*)efficacy calculated using Colby's formula

The results of the experiments show that, owing to the pronounced synergism, the mixtures according to the invention are considerably more effective than previously calculated using Colby's formula.

1-12. (canceled)

13. A method for preparing a fungicidal formulation comprising adding lysine to (a) at least one copper salt as fungicide to increase the fungicidal action of the copper.

14. The method according to claim 13, wherein the at least one copper salt is treated with lysine.

15. The method according to claim 13, wherein the ratio of lysine to copper is from 100:1 to 1:20.

16. The method according to claim 15, wherein the fungicidal formulation further comprises, besides at least one copper salt and lysine,
b) a solvent or solvent mixture, or
c) a basic nitrogen compound, or
d) at least one further fungicidal active ingredient, or
e) adjuvants which are suitable for the formulation, or
f) a combination of at least two of the components mentioned under b) to e).

17. The method according to claim 13, wherein the weight ratios of copper salt and lysine are from 1:7 to 10:1, based on copper.

18. The method according to claim 16, wherein the weight ratios of copper salt and lysine are from 1:7 to 10:1, based on copper.

19. A fungicidal composition comprising at least one copper salt and lysine in weight ratios of from 1:7 to 10:1, based on copper, and additionally comprising solvent or solvent mixture and suitable adjuvants.

20. The fungicidal composition according to claim 19, additionally comprising a basic nitrogen compound in 1 to 10 mol equivalents, based on copper.

21. A fungicidal composition comprising
a′) lysine, at least one copper salt and at least one further fungicidal active ingredient, wherein the at least one copper salt and lysine are in weight ratios of from 1:7 to 10:1, based on copper, and
b′) a solvent or solvent mixture or
c′) a basic nitrogen compound, or
d′) adjuvants which are suitable for the composition, or
v′) a combination of at least two of the components mentioned under b′) to d′).

22. A method for the preparation of a fungicidal formulation comprising
a′) lysine, at least one copper salt and at least one further fungicidal active ingredient, wherein the at least one copper salt and lysine are in weight ratios of from 1:7 to 10:1, based on copper, and
b′) a solvent or solvent mixture or
c′) a basic nitrogen compound, or
d′) adjuvants which are suitable for the formulation, or
v′) a combination of at least two of the components mentioned under b′) to d′), said method comprising either
a) treating copper and basic amino acids together with at least one further fungicidal active ingredient and with adjuvants which are suitable for the formulation, and formulating the mixture; or
b) treating an agrochemical formulation comprising copper as the only fungicidal active ingredient with basic amino acids and with at least one further fungicidal active ingredient and with adjuvants which are suitable for the formulation, and formulating the mixture; or
c) treating an agrochemical formulation comprising copper as the only fungicidal active ingredient with basic amino acids and with an agrochemical formulation of a further fungicidal active ingredient which comprises no copper or lysine; or
d) treating a copper-containing agrochemical formulation which, besides copper, comprises at least one further fungicidal active ingredient with basic amino acids.

23. A method for controlling phytopathogenic fungi comprising applying a fungicidal formulation comprising lysine and at least one copper salt to the pest in question or to the materials, plants, soil and/or seed to be protected from the pest in question.

24. The method of claim 23, wherein the fungicidal formulation comprises at least one copper salt and lysine in weight ratios of from 1:7 to 10:1, based on copper, and additionally comprises solvent or solvent mixture and suitable adjuvants.

25. The method of claim 23, wherein the fungicidal formulation additionally comprises a basic nitrogen compound in 1 to 10 mol equivalents, based on copper.

26. The method of claim 23, wherein the fungicidal composition comprises
a′) lysine, at least one copper salt and at least one further fungicidal active ingredient, and
b′) a solvent or solvent mixture or
c′) a basic nitrogen compound, or
d′) adjuvants which are suitable for the formulation, or
v′) a combination of at least two of the components mentioned under b′) to d′).

27. Seed comprising a copper/lysine mixture in an amount of from 0.1 to 2.5 kg/100 kg.

28. A material comprising copper and lysine in an amount of from 0.0001 g to 2 kg per cubic meter.

29. Timber comprising copper and lysine in an amount of from 0.0001 g to 2 kg per cubic meter.
